(19) United States
(12) Patent Application Publication
(10) Pub. No.: US 2006/0238106 A1
(43) Pub. Date: Oct. 26, 2006

(54) Electron emission display

(76) Inventors: Jung Ho Kang, Yongin (KR); Sueng Joo Yoo, Suwon (KR); Zin Min Park, Cheonan (KR); Soo Joung Lee, Anyang (KR); Su Kyung Lee, Cheonan (KR)

Correspondence Address: CHRISTIE, PARKER & HALE, LLP, PO BOX 7068, PASADENA, CA, 91109-7068, US

(21) Appl. No.: 11/264,372

(22) Filed: Oct. 31, 2005

(30) Foreign Application Priority Data
Oct. 29, 2004 (KR) 2004-86957

(51) Int. Cl. H01J 63/04; H01J 1/62

(52) U.S. Cl. 313/496

(57) ABSTRACT

An electron emission display comprising an electron emission substrate and an image forming substrate is provided. The electron emission substrate comprises at least one electron emission device. The image forming substrate comprises at least one fluorescent layer and at least one resistance layer in contact with the fluorescent layer. In use, power is applied to the fluorescent layers through the resistance layer. This configuration prevents discharge and arc in localized regions of the image forming substrate.

### CROSS-REFERENCE TO RELATED APPLICATION

This application claims priority to and the benefit of Korean Patent Application No. 2004-86957, filed Oct. 29, 2004, in the Korean Intellectual Property Office, the entire content of which is incorporated herein by reference.

### FIELD OF THE INVENTION

The present invention relates to an electron emission display capable of preventing discharge and arc during display. More particularly, the present invention is directed to an electron emission display comprising an image forming substrate having at least one fluorescent layer and at least one resistance layer. Power is applied to the at least one fluorescent layer through the at least one resistance layer.

### BACKGROUND OF THE INVENTION

In general, electron emission displays emit electrons from electron emission devices that are electrically connected to cathode electrodes. The electron emission devices are connected to the cathode by applying electric fields between the cathode electrodes and gate electrodes, creating quantum mechanical tunneling effects. Electron emission displays use either hot cathodes or cold cathodes as electron sources. Electron emission displays using cold cathodes may be classified into field emitter array (FEA) types, surface conduction emitter (SCE) types, metal-insulator-metal (MIM) types, metal-insulator-semiconductor (MIS) types, ballistic electron surface emitting (BSE) types, and the like.

Electron emission devices are used to form electron emission displays, various backlights, electron beam apparatuses for lithography, and the like. A typical electron emission display comprises an electron emission device for emitting electrons. The electron emission display also comprises fluorescent layers with which the emitted electrons collide and emit light. The electron emission display typically comprises a plurality of electron emission devices and control electrodes on the electron emission substrate for controlling electron emission. The electron emission display also comprises fluorescent layers on the image forming substrate, and accelerating electrodes connected to the fluorescent layers to accelerate the emitted electrons toward the fluorescent layers.

As described above, conventional electron emission displays have resistance layers surrounding the image forming substrates. These resistance layers are said to suppress discharge and arc generated from the image forming substrate. However, these electron emission displays can be damaged by arc generated in the inner regions of the image forming substrates, which is where the fluorescent layers are positioned. As a result, the lives of the fluorescent layers are reduced. In addition, laser trimming methods are often used to form the resistance layers on the image forming substrates to connect the resistance layers and the electrodes. However, this method for forming the resistance layers gives low productivity, thereby decreasing yield.

### SUMMARY OF THE INVENTION

In one embodiment of the present invention an electron emission display comprises a resistance layer formed in the center of an image forming substrate. High driving voltages are applied to fluorescent layers of the image forming substrate through the resistance layer.

In one exemplary embodiment of the present invention, an electron emission display comprises an electron emission substrate comprising at least one electron emission device. The electron emission display further comprises an image forming substrate comprising at least one fluorescent layer and at least one resistance layer in contact with the fluorescent layer. Electrons emitted from the electron emission device collide with the fluorescent layer, thereby emitting light. In use, power is applied to the fluorescent layer through the resistance layer.

In another exemplary embodiment of the present invention, an electron emission display comprises an electron emission substrate comprising a plurality of electron emission devices positioned in a matrix pattern. The electron emission display further comprises an image forming substrate comprising at least one fluorescent layer and at least one resistance layer in contact with the fluorescent layer and surrounding the fluorescent layer. Electrons emitted from the electron emission devices collide with the fluorescent layer, thereby emitting light. In use, power is applied to the fluorescent layer through the resistance layer.

In one embodiment, the resistance layer has a sheet resistance of about 10³ to about 10¹⁴ Ω. In another embodiment, the resistance layer has a sheet resistance of about 10⁷ to about 10¹⁴ Ω. The resistance layer may comprise a material selected from the group consisting of Co, Cr, chromium oxides (CrOx) and ruthenium oxides (RuOx). The resistance layer may be black.

In one embodiment, the at least one fluorescent layer and at least one resistance layer form at least one sub-pixel. In another embodiment, the at least one fluorescent layer and at least one resistance layer form at least one pixel.

In an alternative embodiment, the electron emission display further comprises a light-shielding layer between the fluorescent layer and the resistance layer. The light-shielding layer can comprise a conductive material.

In one embodiment, the electron emission substrate comprises at least one cathode electrode and at least one gate electrode, the cathode electrode being insulated from and intersecting the gate electrode. At least one electron emission device is electrically connected to the cathode electrode. The electron emission substrate may comprise at least one electron emission device positioned in a matrix pattern at an intersection of the cathode electrode and gate electrode. The electron emission substrate may also comprise a third electrode for directing the emitted electrons from the electron emission devices to the fluorescent layers. The electron emission display may further include a spacer for separating the electron emission substrate and the image forming substrate.

### BRIEF DESCRIPTION OF THE DRAWINGS

The above and other features and advantages of the present invention will become more apparent by reference to the following detailed description when considered in conjunction with the accompanying drawings, in which:

FIG. 1 is a schematic cross-sectional view of an electron emission display according to one embodiment of the present invention;

FIG. 2A is a schematic plan view of a representative portion of an image forming substrate of the electron emission display of FIG. 1;

FIG. 2B is a cross-sectional view the image forming substrate of FIG. 2A, taken along line 2B-2B;

FIG. 3A is a schematic plan view of a representative portion of an image forming substrate according to an alternative embodiment of the present invention;

FIG. 3B is a cross-sectional view of the image forming substrate of FIG. 3A, taken along line 3B-3B;

FIG. 4A is a schematic plan view of a representative portion of an image forming substrate according to yet another embodiment of the present invention;

FIG. 4B is a cross-sectional view of the image forming substrate of FIG. 4A, taken along line 4B-4B;

FIG. 5A is a schematic plan view of a representative portion of an image forming substrate according to still another embodiment of the present invention; and

FIG. 5B is a cross-sectional view of the image forming substrate of FIG. 5A, taken along line 5B-5B.

### DETAILED DESCRIPTION

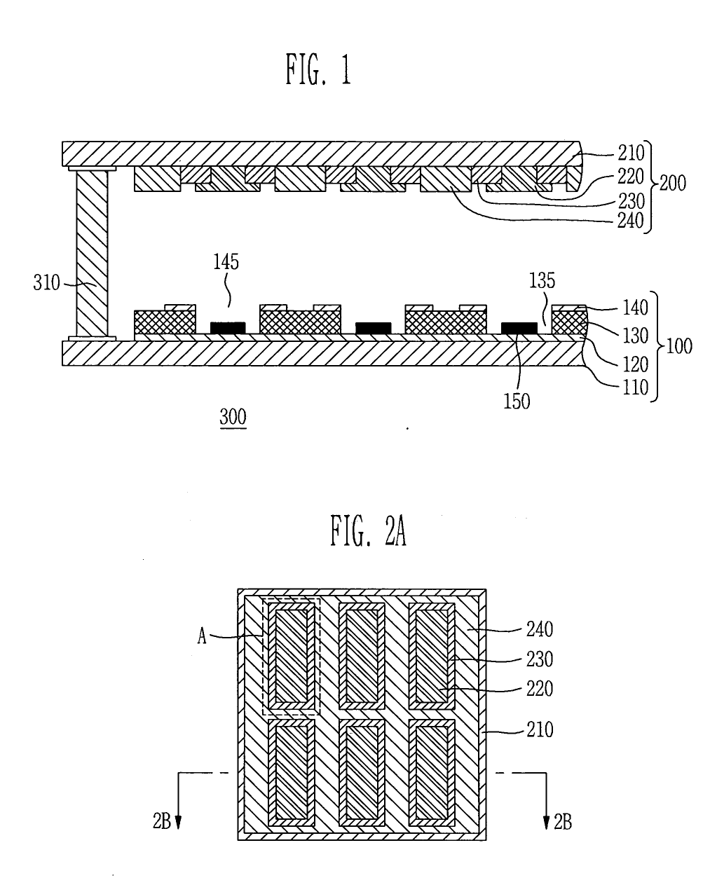

Exemplary embodiments of the present invention will now be described with reference to the accompanying drawings. FIG. 1 is a schematic cross-sectional view of an electron emission display according to one embodiment of the present invention. Referring to FIG. 1, an electron emission display 300 comprises an electron emission substrate 100 comprising at least one electron emission device 150, and an image forming substrate 200 comprising at least one fluorescent layer 220 and at least one resistance layer 240 in contact with the fluorescent layer 220. Electrons emitted from the electron emission device 150 on the electron emission substrate collide with the fluorescent layer 220, thereby emitting light. In use, power is applied to the fluorescent layer 220 through the resistance layer 240.

More specifically, the electron emission substrate 100 comprises at least one electron emission device 150 which emits electrons by an electric field formed between a cathode electrode 120 and a gate electrode 140. The electron emission substrate 100 comprises a bottom layer 110, at least one cathode electrode 120, at least one gate electrode 140, at least one insulating layer 130 for insulating the cathode electrode 120 from the gate electrode 140, at least one electron emission device 150 connected to the cathode electrode 120, and a grid electrode (not shown). In this embodiment, the cathode electrode 120 and the gate electrode 140 lie perpendicular to each other. In an alternative embodiment, the cathode electrode 120 and the gate electrode 140 lie parallel to each other.

At least one cathode electrode 120 is disposed on the bottom layer 110 in a predetermined pattern, for example a striped pattern. The bottom layer 110 comprises any conventional material, for example glass or silicon. The bottom layer 110 can be formed by a rear surface exposure method using carbon nanotube (CNT) paste. When formed in this manner, the bottom layer 110 preferably comprises a transparent substrate such as glass.

The cathode electrode 120 directs data signals and/or scan signals from data driving regions (not shown) and/or scan driving regions (not shown) to the electron emission device 150. The electron emission substrate 100 comprises an electron emission device 150 positioned at the intersection of the cathode electrode 120 and the gate electrode 140. The cathode electrode 120 may comprise indium tin oxide (ITO).

The insulating layer 130 is positioned on the bottom layer 110 covering the cathode electrode 120 to electrically insulate the cathode electrode 120 from the gate electrode 140. The insulating layer 130 comprises at least one opening 135 located at an intersection between the cathode electrode 120 and the gate electrode 140. The opening 135 exposes the cathode electrode 120.

The gate electrode 140 is positioned on the insulating layer 130 in a predetermined pattern, for example, a striped pattern, and is positioned in a direction perpendicular to the cathode electrode 120. The gate electrode 140 directs data signals and/or scan signals from data driving regions (not shown) and/or scan driving regions (not shown) to the electron emission device 150. The gate electrode 140 comprises at least one opening 145, corresponding to the opening 135 in the insulation layer 130, for exposing the electron emission device 150.

The electron emission device 150 is electrically connected to the cathode electrode 120 and is positioned on the cathode electrode 120 in a position corresponding to the opening 135 in the insulation layer and the opening 145 in the gate electrode. In one embodiment, the electron emission device comprises a material selected from the group consisting of carbon nanotubes, graphite, graphite nano fibers, diamond-like carbon, C₆₀, silicon nano wires, and the like.

As described above, the electron emission substrate 100 comprises a plurality of electron emission devices 150, each positioned at an intersection of a cathode electrode 120 with a gate electrode 140. The electron emission devices 150 are positioned on the electron emission substrate 100 in a predetermined pattern, for example, a matrix pattern. The electron emission substrate 100 comprises a cathode electrode 120 and a gate electrode 140 positioned perpendicular to one another, an insulating layer 130 for insulating the cathode electrode 120 from the gate electrode 140, and an electron emission device 150 electrically connected to the cathode electrode 120. At least one electron emission device 150 corresponds in position to a fluorescent layer 220 on the image forming substrate 200.

The grid electrode (not shown) is positioned on the gate electrode 140, and comprises at least one opening through which emitted electrons can pass. The grid electrode directs the electrons emitted from the electron emission device 150 to the fluorescent layer 220, and prevents damage to the electrodes from arc discharge. In one embodiment, the grid electrode comprises a conductive mesh sheet.

The image forming substrate 200 comprises a top layer 210, at least one fluorescent layer 220 positioned on the top layer 210, and at least one light-shielding layer 230 in contact with and surrounding the fluorescent layer 220. Electrons emitted from the electron emission devices 150 on the electron emission substrate 100 collide with the fluorescent layers 220, thereby emitting light. The image forming substrate 200 further comprises a resistance layer 240 surrounding the periphery of at least one fluorescent layer 220. In embodiments comprising light-shielding layers 230, the resistance layer 230 may be positioned surrounding at least one light-shielding layer 230. In use, power is applied to the fluorescent layers 220 through the resistance layer 240.

The fluorescent layers 220 emit light when electrons emitted by the electron emission devices collide with the fluorescent layers 220. The fluorescent layers 220 are selectively positioned on the top layer 210 of the image forming substrate 200, and are spaced apart from each other by a predetermined interval. Each fluorescent layer 220 comprises a single layer. For example, each fluorescent layer may comprise a fluorescent layer, pixel unit or line unit for displaying red (R), green (G) or blue (B) colors. In one embodiment, the top layer 210 comprises a transparent material.

The light-shielding layers 230 contact with the fluorescent layers 220, which are spaced apart from each other by a predetermined interval. The light-shielding layers 230 improve the contrast ratio by absorbing and blocking external light and preventing optical crosstalk. In one embodiment, the light-shielding layers 230 contact the fluorescent layers 220 and surround the peripheries of the fluorescent layers 220. Similarly, the resistance layers 240 contact the fluorescent layers 220 and surround the fluorescent layers 220 to form the image forming substrate 200.

As noted above, the resistance layers 240 surround the peripheries of the fluorescent layers 220. High electron acceleration voltages (anode voltages) are applied from an external power source (not shown) to the image forming substrate 200. In this embodiment, these voltages are applied to the light-shielding layers 230 and the fluorescent layers 220 through the resistance layers 240. Therefore, the light-shielding layers 230 each comprise a conductive material.

The resistance layers 240 block discharge and arcing in their respective regions of the image forming substrate 200. As such, the resistance layers 240 filter out unstable and unexpected high acceleration voltages, such as impulse. As a result, only stable voltages are applied to the image forming substrate 200. In one embodiment, the resistance layers 240 each have a sheet resistance of about 10³ about 10¹⁴ Ω. Depending on power consumption of the electron emission display, the resistance layers 240 may each alternatively have a sheet resistance of about 10⁷ to about 10¹⁴ Ω. The resistance layers 240 having these sheet resistance values may comprise a material selected from the group consisting of Co, Cr, chromium oxides (CrOx) and ruthenium oxides (RuOx). The resistance layer 240 comprises a paste, which may be formed by printing, deposition, table coating and the like. In addition, the resistance layers 240 may be black, like the light-shielding layers 230, to prevent optical crosstalk.

The electron emission display 300 further comprises a spacer 310 to separate the electron emission substrate 100 from the image forming substrate 200. A positive voltage is applied to the cathode electrodes 120, a negative voltage is applied to the gate electrodes 140, and a positive voltage is applied to the light-shielding layers 230. As a result, an electric field is generated around the electron emission devices 150 due to the voltage difference between the cathode electrodes 120 and the gate electrodes 140. This electric field causes the electron emission devices 150 to emit electrons. The high voltage applied to the image forming substrate 200 then induces the collision of the emitted electrons with the fluorescent layers 220 corresponding to the position of the respective electron emission devices 150, thereby emitting light and displaying an image.

Various alternative embodiments of the present invention will now be described. For example, in one embodiment each fluorescent layer comprises a sub-pixel unit, a pixel unit, or a line unit. In another embodiment, the resistance layer functions as the light-shielding layer.

FIG. 2A is a schematic plan view of a representative portion of an image forming substrate of the electron emission display of FIG. 1. FIG. 2B is a cross-sectional view of the image forming substrate of FIG. 2A, taken along the line 2B-2B. FIGS. 2A and 2B illustrate an embodiment of the present embodiment in which the fluorescent layers form at least one sub-pixel.

Referring to FIGS. 2A and 2B, an image forming substrate 200 comprises at least one fluorescent layer 220 formed on a top layer 210 of the substrate 200. At least one light-shielding layer 230 is connected to each fluorescent layer 220 and surrounds the periphery of the fluorescent layer 220. The fluorescent layer 220 and the light-shielding layer 230 form a single sub-pixel, designated A in FIG. 2A. A resistance layer 240 is connected to and surrounds the periphery of each light-shielding layer 230, as shown in FIG. 2A. In this configuration, a voltage applied to the image forming substrate 200 is individually applied to each of the conductive light-shielding layers 230 and fluorescent layers 220 through the resistance layer 240. In this embodiment, the resistance layer 240 may perform the function of the light-shielding layers 230. Therefore, when the resistance layer 240 comprises a black material, the light-shielding layers 230 may be omitted.

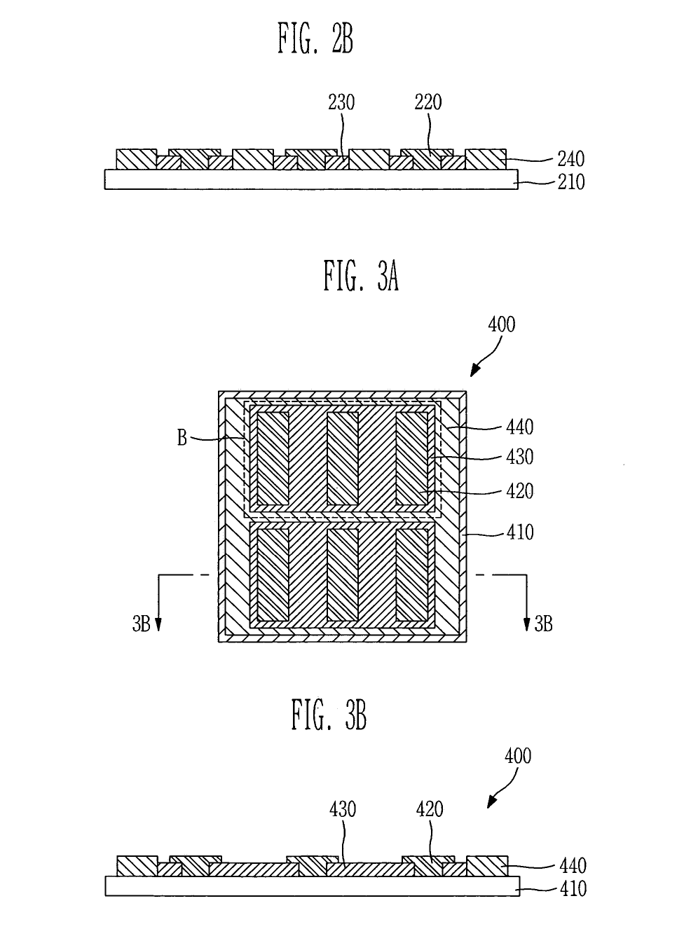

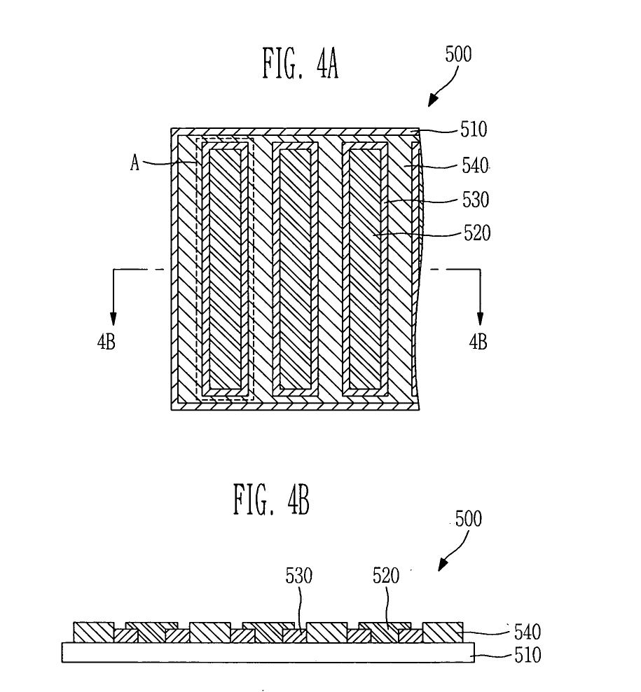

FIG. 3A is a schematic plan view of a representative portion of an image forming substrate 400 according to an alternative embodiment of the present invention. FIG. 3B. is a cross-sectional view of the image forming substrate 400 of FIG. 3B, taken along line 3B-3B. FIGS. 3A and 3B illustrate an alternative embodiment of the present invention in which the fluorescent layers form at least one pixel.

Referring to FIGS. 3A and 3B, an image forming substrate 400 comprises at least one fluorescent layer 420 positioned on a top layer 410. At least one light-shielding layer 430 is connected to and surrounds the periphery of at least one of the fluorescent layers 420. A resistance layer 440 is connected to and surrounds the at least one light-shielding layer 430, as shown in FIG. 3A. The fluorescent layers 420 and the light-shielding layers 430 form at least one sub-pixel, designated B in FIG. 3A. In this embodiment, the fluorescent layers 420 may comprise a single pixel. Alternatively, the fluorescent layers 420 may comprise at least two pixels, as shown in FIG. 3A. In this embodiment, a voltage applied to the image forming substrate 400 is applied to the fluorescent layers 420 through the resistance layer 440.

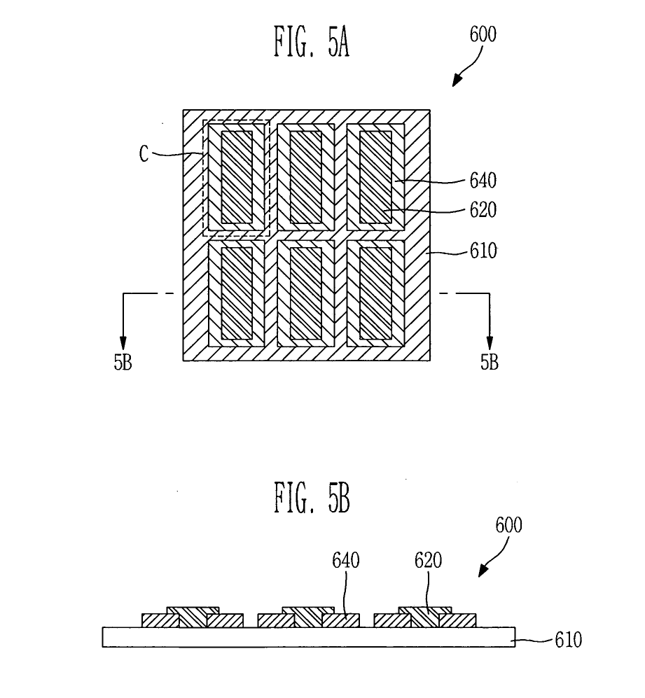

FIG. 4A is a schematic plan view of a representative portion of an image forming substrate 500 according to another alternative embodiment of the present invention. FIG. 4B is a cross-sectional view of the image forming substrate 500 of FIG. 4A, taken along line 4B-4B. FIGS. 4A and 4B illustrate another alternative embodiment of the present invention in which the fluorescent layers form at least one line.

Referring to FIGS. 4A and 4B, an image forming substrate 500 comprises at least one fluorescent layer 520 formed on a top layer 510. At least one light-shielding layer 530 is connected to and surrounds each fluorescent layer 520, as shown in FIG. 4A. A resistance layer 540 is connected to and surrounds each light-shielding layer 530, as shown in FIG. 4A. In this embodiment, the fluorescent layers 220 and light-shielding layers 520 may form a single line. Alternatively, the fluorescent layers 520 and light-shielding layers 530 may form at least two lines. According to this embodiment, a voltage applied to the image forming substrate 500 is applied to the fluorescent layers 520 through the resistance layer 540.

FIG. 5A is a schematic plan view of a representative portion of an image forming substrate 600according to yet another embodiment of the present invention. FIG. 5B is a cross-sectional view of the image forming substrate 600 of FIG. 5A, taken along line 5B-5B.

Referring to FIGS. 5A and 5B, an image forming substrate 600 comprises at least one fluorescent layer 620 formed on a top layer 610. A resistance layer 640 is connected to and surrounds each fluorescent layer 620, as shown in FIG. 5A. In this embodiment, the resistance layer 640 performs the function of the light-shielding layer of other embodiments, thereby simplifying the structure of the image forming substrate 600. In this embodiment, the resistance layer 640 comprises a black material. Although FIG. 5A depicts each fluorescent layer 620 and resistance layer 640 forming a sub-pixel, designated C in FIG. 5A, it is understood that the fluorescent layers 620 and resistance layers 640 can alternatively form a pixel, as described in connection with FIGS. 3A and 3B, or a line, as described in connection with FIGS. 4A and 4B. In this embodiment, stable acceleration voltages are applied to the fluorescent layers through the resistance layer, thereby blocking discharge and arc in localized regions of the image forming substrate.

As discussed above, the electron emission displays of the present invention prevent discharge and arc in localized regions of the image forming substrates by adapting the resistance layer to surround the fluorescent layers.

Although exemplary embodiments of the present invention have been described, those skilled in the art will understand that various modifications and variations can be made without departing from the spirit and scope of the present invention as disclosed in the accompanying claims.

What is claimed is:

1. An electron emission display comprising:
an electron emission substrate comprising at least one electron emission device; and
an image forming substrate comprising:
at least one fluorescent layer; and
at least one resistance layer surrounding the at least one fluorescent layer, wherein the resistance layer is adapted to deliver a voltage to the at least one fluorescent layer.

2. The electron emission display according to claim 1, wherein the at least one resistance layer contacts the at least one fluorescent layer.

3. The electron emission display according to claim 1, wherein the resistance layer has a sheet resistance of about 10³ to about 10¹⁴ Ω.

4. The electron emission display according to claim 3, wherein the resistance layer has a sheet resistance of about 10⁷ to about 10¹⁴ Ω.

5. The electron emission display according to claim 1, wherein the resistance layer comprises a material selected from the group consisting of Co, Cr, chromium oxides (CrOx) and ruthenium oxides (RuOx).

6. The electron emission display according to claim 1, wherein the at least one fluorescent layer and at least one resistance layer form at least one sub-pixel.

7. The electron emission display according to claim 1, wherein the at least one fluorescent layer and at least one resistance layer form at least one pixel.

8. The electron emission display according to claim 1, wherein the at least one fluorescent layer and at least one resistance layer form at least one line.

9. The electron emission display according to claim 1, wherein the resistance layer comprises a black material.

10. The electron emission display according to claim 1, further comprising at least one light-shielding layer positioned between the at least one fluorescent layer and the resistance layer, wherein the at least one light-shielding layer surrounds the at least one fluorescent layer, and the resistance layer surrounds the at least one light shielding-layer.

11. The electron emission display according to claim 10, wherein the light-shielding layer comprises a conductive material.

12. The electron emission display according to claim 1, wherein the electron emission substrate further comprises a cathode electrode and a gate electrode, wherein the cathode electrode and gate electrode are positioned substantially perpendicular to each other, the at least one electron emission device being positioned in a matrix pattern at an intersection of the cathode electrode and gate electrode.

13. The electron emission display according to claim 12, wherein the electron emission substrate further comprises an insulation layer positioned between the cathode electrode and gate electrode, the electron emission device being electrically connected to the cathode electrode.

14. The electron emission display according to claim 12, wherein the electron emission substrate further comprises a third electrode for directing electrons emitted from the electron emission device to the fluorescent layers on the image forming substrate.

15. The electron emission display according to claim 1, further comprising a spacer for separating the electron emission substrate from the image forming substrate.

16. An electron emission display comprising:
an electron emission substrate comprising at least one electron emission device positioned on the electron emission substrate in a matrix pattern; and
an image forming substrate comprising:
at least one fluorescent layer, and
at least one resistance layer surrounding the at least one fluorescent layer, wherein the resistance layer is adapted to deliver a voltage to the at least one fluorescent layer.

17. The electron emission display according to claim 16, wherein the resistance layer contacts the at least one fluorescent layer.

18. The electron emission display according to claim 16, wherein the resistance layer has a sheet resistance of about 10³ to about 10¹⁴ Ω.

19. The electron emission display according to claim 16, wherein the resistance layer has a sheet resistance of about 10⁷ to about 10¹⁴ Ω.

20. The electron emission display according to claim 16, wherein the resistance layer comprises a material selected from the group consisting of Co, Cr, chromium oxides (CrOx) and ruthenium oxides (RuOx).

21. The electron emission display according to claim 16, wherein the at least one fluorescent layer and at least one resistance layer form at least one sub-pixel.

22. The electron emission display according to claim 16, wherein the at least one fluorescent layer and at least one resistance layer form at least one pixel.

23. The electron emission display according to claim 16, wherein the at least one fluorescent layer and at least one resistance layer form at least one line.

24. The electron emission display according to claim 16, wherein the resistance layer comprises a black material.

25. The electron emission display according to claim 16, wherein the image forming substrate further comprises at least one light-shielding layer positioned between the at least one fluorescent layer and the resistance layer.

26. The electron emission display according to claim 25, wherein the light-shielding layer comprises a conductive material.

27. An electron emission display comprising:
an electron emission substrate comprising at least one electron emission device; and
an image forming substrate comprising:
at least one fluorescent layer,
at least one light-shielding layer surrounding the at least one fluorescent layer, and
at least one resistance layer surrounding the at least one light-shielding layer, wherein the resistance layer is adapted to deliver a voltage to the at least one light-shielding layer and at least one fluorescent layer.

28. The electron emission display according to claim 27, wherein the resistance layer has a sheet resistance of about 10³ to about 10¹⁴ Ω.

29. The electron emission display according to claim 27, wherein the resistance layer has a sheet resistance of about 10⁷ to about 10¹⁴ Ω.

30. The electron emission display according to claim 27, wherein the resistance layer comprises a material selected from the group consisting of Co, Cr, chromium oxides (CrOx) and ruthenium oxides (RuOx).

31. The electron emission display according to claim 27, wherein the at least one fluorescent layer and at least one light-shielding layer form at least one sub-pixel.

32. The electron emission display according to claim 27, wherein the at least one fluorescent layer and at least one light-shielding layer form at least one pixel.

33. The electron emission display according to claim 27, wherein the at least one fluorescent layer and at least one light-shielding layer form at least one line.

34. The electron emission display according to claim 27, wherein the light-shielding layer comprises a conductive material.
